(19) United States
(12) Patent Application Publication
(10) Pub. No.: US 2012/0159324 A1
(43) Pub. Date: Jun. 21, 2012

(54) SYSTEMS AND METHODS FOR SOFTWARE STATE CAPTURE AND PLAYBACK

(75) Inventors: Rodolfo Chavez, Bensenville, IL (US); Steven Linthicum, Lake In the Hills, IL (US); Anthony Ricamato, West Chicago, IL (US); Eric Jester, Hoffman Estates, IL (US); Luke Iver Sandberg, Barrington, IL (US)

(73) Assignee: General Electric Company, Schenectady, NY (US)

(21) Appl. No.: 12/971,809

(22) Filed: Dec. 17, 2010

(51) Int. Cl. G06F 3/00

(52) U.S. Cl. 715/704

(57) ABSTRACT

Example systems, methods, and apparatus for application state capture and playback are provided. An example system includes a user interface to display an application and associated data to a user for interaction by the user. The user interface includes a player to facilitate playback of one or more saved states from the application; each of the saved state(s) includes an application setting and associated data. The player is to include a plurality of controls to facilitate selection, playback, and modification of each of the saved state(s). The player is to provide a list of saved state(s) for selection and playback by the user. The playback of a selected state is to automatically take the user to a point in the application execution associated with the application setting and associate data and to allow the user to dynamically execute the application from that point.

### FIELD

The present invention generally relates to capturing a state of a healthcare application. In particular, the present invention relates to systems, methods, and apparatus for recording, ordering, and playback of a healthcare application's state.

### BACKGROUND

A clinical or healthcare environment is a crowded, demanding environment that would benefit from organization and improved ease of use of imaging systems, data storage systems, and other equipment used in the healthcare environment. A healthcare environment, such as a hospital or clinic, encompasses a large array of professionals, patients, equipment and computerized information systems.

Healthcare environments, such as hospitals or clinics, include information systems, such as healthcare information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information for a particular information system may be centrally stored or divided at a plurality of locations. Healthcare practitioners may desire to access patient information or other information at various points in a healthcare workflow. For example, during an imaging scan of a patient, medical personnel may access patient information, such as a patient exam order, that are stored in a medical information system. Alternatively, medical personnel may enter new information, such as history, diagnostic, and/or treatment information, into a medical information system during an imaging scan. Different clinical departments and different clinical systems gather patient information in different ways and in different forms and often separately store that information.

### BRIEF SUMMARY

Certain examples provide systems, methods, and apparatus for application state capture and playback.

Certain examples provide an application state capture and playback system. The system includes a user interface to display an application and associated data to a user for interaction by the user. The user interface includes a player to facilitate playback of one or more saved states from the application; each of the one or more saved states includes an application setting and associated data. The player is to include a plurality of controls to facilitate selection, playback, and modification of each of the one or more saved states. The player is to provide a list of one or more saved states for selection and playback by the user. The playback of a selected state is to automatically take the user to a point in execution of the application associated with the application setting and associate data and to allow the user to dynamically execute the application from the point.

Certain examples provide a tangible computer readable storage medium including executable program instructions which, when executed by a computer processor, cause the computer to implement an application state capture and playback system. The system includes a user interface to display an application and associated data to a user for interaction by the user. The user interface includes a player to facilitate playback of one or more saved states from the application; each of the one or more saved states includes an application setting and associated data. The player is to include a plurality of controls to facilitate selection, playback, and modification of each of the one or more saved states. The player is to provide a list of one or more saved states for selection and playback by the user. The playback of a selected state is to automatically take the user to a point in execution of the application associated with the application setting and associate data and to allow the user to dynamically execute the application from the point.

Certain examples provide a computer-implemented method including displaying an application and associated data to a user for interaction by the user via a user interface. The method includes providing, via the user interface, a player to facilitate playback of one or more saved states from the application, each of the one or more saved states including an application setting and associated data, the player including a plurality of controls to facilitate selection, playback, and modification of each of the one or more saved states, the player to provide a list of one or more saved states for selection and playback by the user, the playback of a selected state to automatically take the user to a point in execution of the application associated with the application setting and associate data and to allow the user to dynamically execute the application from the point. The method includes accepting selection by the user of a saved state, via the player, for playback. The method includes initiating playback of the selected state to bring the user to the point in the execution of the application associated with the saved state.

### BRIEF DESCRIPTION OF SEVERAL VIEWS OF THE DRAWINGS

FIG. 1 illustrates an example software state player.

FIG. 2 depicts an example summary state selected from a list of software states for a selected review sequence and conveyed to a user.

FIG. 3 illustrates an example of a playback transition from a first state to a second state.

FIG. 4 illustrates an example software application state capture and playback system.

FIG. 5 depicts a flow diagram for an example method for software application state capture and playback.

FIG. 6 shows a block diagram of an example clinical information system capable of implementing the example methods and systems described herein.

FIG. 7 is a block diagram of an example processor system that may be used to implement systems, apparatus, and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EXAMPLES

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, in an embodiment, at least one of the elements is hereby expressly defined to include a tangible medium such as a memory, DVD, CD, Blu-ray, etc., storing the software and/or firmware.

Certain examples provide healthcare and/or other application software state capture and playback. Certain examples facilitate recording, ordering, and playback of an application's state.

Certain examples provide systems, apparatus, and methods for recording, ordering, and playback of software states from within their original software application. A state includes all data and user interface information to re-establish an instance of the software, for example. For example, the data can include a document identifier, and the user interface information can include a selected item in a list box. Each state corresponds to a list of states, known as a review, and each state is assigned a sequence order within the review, for example. The sequence of states is navigable and the sequence can be reordered, for example. During playback, the sequence is navigated from a first state to a last state with a configurable wait time in between each state, for example. Playback can be paused, allowing the user to interact with the application/data, and resumed at anytime. These reviews can be shared between users, allowing for collaboration, for example.

Upon initialization, either by a user or automatically by a system, data and user interface information are collected for a current software state. The collected information is stored in a machine-readable form, such as binary. The state is added to the end of a selected review. The state is given a sequence number corresponding to the last item in the selected review. The state can be moved up and down in the sequence by swapping sequence numbers with a state before and/or after it. During playback, the first state is loaded. After a configurable amount of time, the second state is loaded. This continues until the end of the review is reached.

Software that is used mainly for presenting and manipulating data requires a large number of user interactions. These user interactions (e.g., mouse clicks, data entry, etc.) consume users' time. When the user interactions are repeated over and over and the amount of data is large, the total time spent in navigating an application adds up quickly. When the user interactions are complicated, steps and/or elements in the process can be forgotten. Certain examples help reduce a number of user interactions to return to a software state and reduce time spent navigating the data and the software itself. The playback and navigation of the software states can be used to establish steps and/or elements in a workflow and/or to create presentations of data within the environment of the software, for example. For example, in a healthcare setting, a tumor review board application would allow users to “fly through” established patient data points and data forms.

Certain examples can be used to record a sequence of application states and then load them in order directly in an application. This can aid reproduction of software problem reports, for example. Application state sequence recording and reloading can serve as a more robust system for logging usage and errors in software, for example. From a commercial perspective, certain examples can help software users streamline their work processes, saving time and increasing throughput. Using certain examples, training users can be simplified, allowing new users to become productive more quickly.

Rather than simply providing work instructions and process documentations (e.g., slide presentations used to document steps in using software by taking screenshots of the application at each step in the process), certain examples save software states internally and allow a user to interact with one or more saved states. A software state can include one or more pieces of data and/or user interface information. Therefore, there can be multiple types of software states within a given application. This makes recording software states flexible. The software state is stored in a machine-readable form (e.g., a binary), which allows for transmission, storage, manipulation, etc. In certain examples, state(s) can be saved internally to a software application and/or system (e.g., a clinical information system). In some examples, an external application is provided to handle the capture of states and feed them back into a target application.

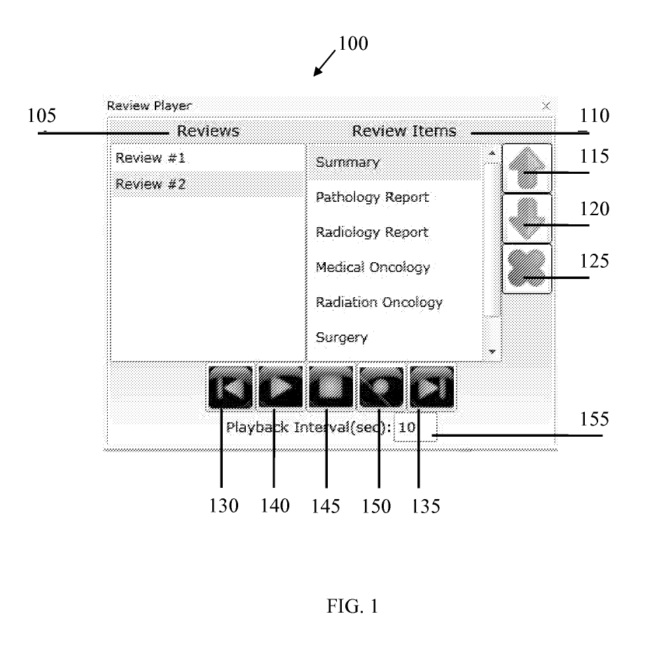

FIG. 1 illustrates an example software state player 100. The review player 100 includes a list of reviews 105 available for user selection and playback. A user can select a review from the list of reviews 105 for playback. For a selected review, the player interface 100 includes a list of software states 110. For example, the list of review items 110 can include a summary, pathology report, radiology report, medical oncology, radiation oncology, surgery, etc. One or more controls allow a user to move a selected state up 115 the list 110, move a selected state down 120 the list 110, delete 125 a selected state from the list, etc.

For a selected state to be reviewed, one or more controls facilitate playback of the selected software state. As shown in the example of FIG. 1, a control 130 allows a user to move to a previous state in a sequence of saved states. Another control 135 allows the user to move to a next state the sequence. The user can start 140 playback of one or more states in the sequence based on a certain interval 155 between each state. Playback can be stopped 145, and a current state can be recorded 150 and added to the selected review sequence. The playback interval 155 (e.g., ten seconds) can be selected and/or otherwise specified by the user, for example.

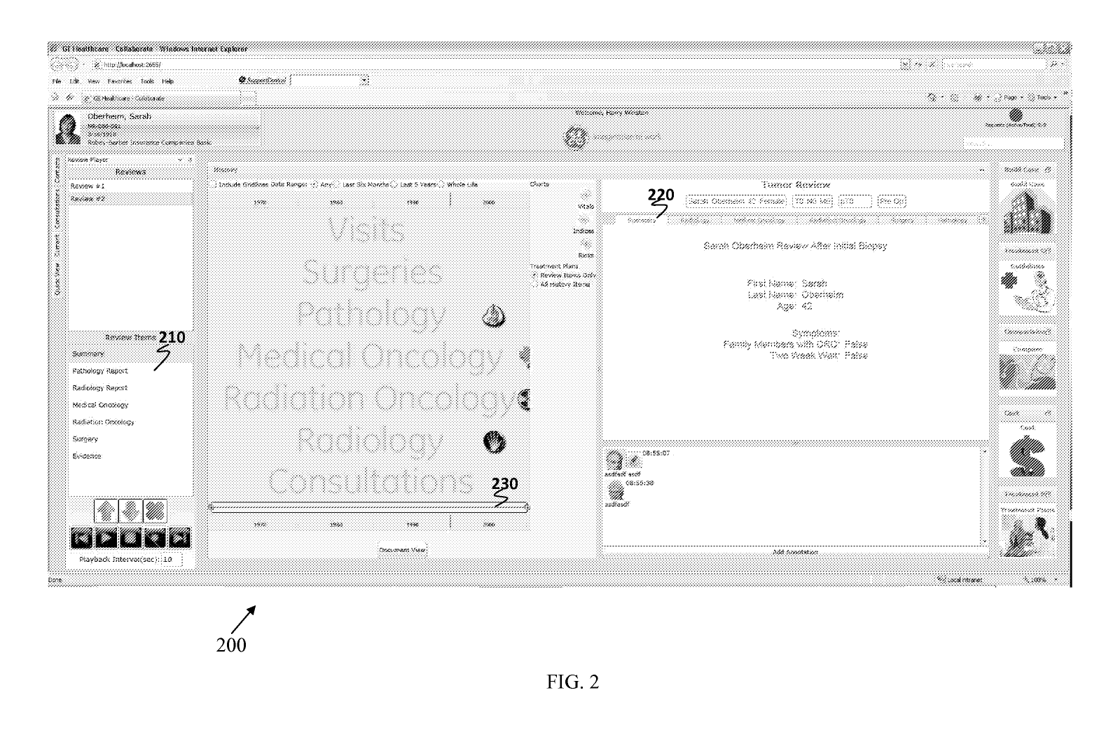

As depicted in the example of FIG. 2, a summary state can be selected from a list of software states for a selected review sequence. The summary state is conveyed to a user via a user interface 200. The interface 200 includes a list of review items including a selected state 210 (e.g., the summary state). Additionally, the example interface 200 includes a selected tab 220 from a number of one or more tabs available for selection (e.g., summary, radiology, medical oncology, radiation oncology, surgery, pathology, etc.). The example interface 200 also includes a selected date range 230 for playback and review. Once the summary state has been selected for playback from the list, the user is brought into the application in the summary state and can manipulate, modify, and/or execute functionality in the summary state starting from the saved state information, for example.

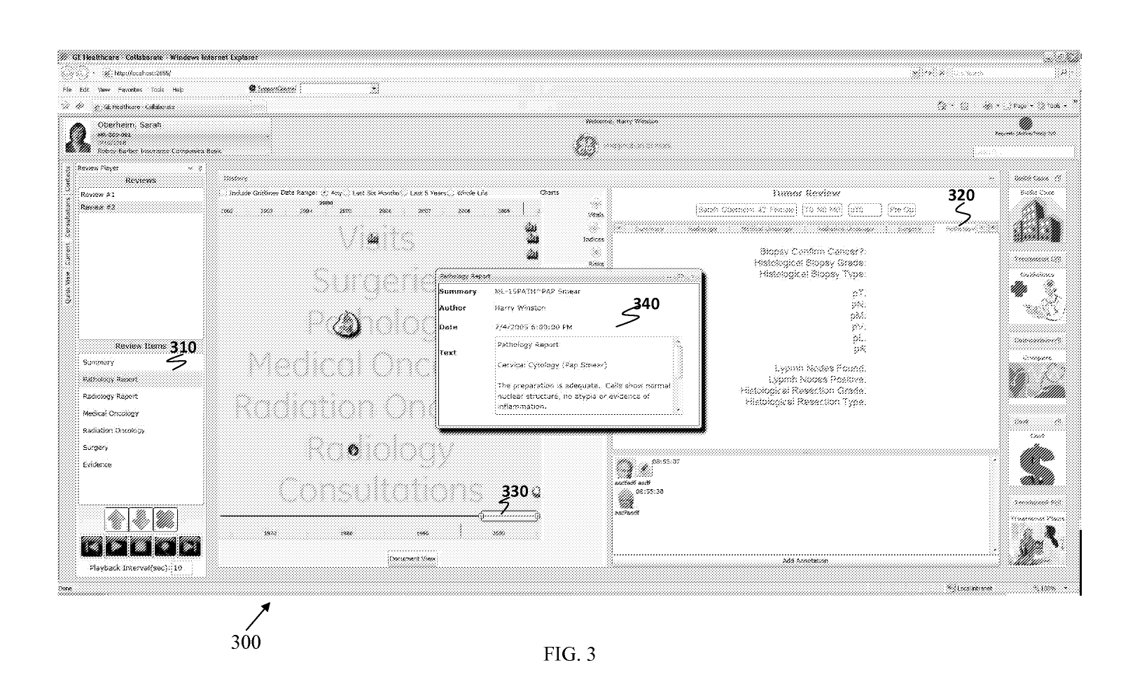

FIG. 3 illustrates an example of a playback transition from a first state to a second state. As depicted in the example of FIG. 3, a pathology report state 310 can be selected from a list of software states for a selected review sequence. As shown in an example interface 300 of FIG. 3, the pathology report state 310 can follow after playback of a summary state. The pathology report state 310 can be followed by a next state in the list of states for review, for example.

The example interface 300 includes a selected tab 320 from a number of one or more tabs available for selection (e.g., summary, radiology, medical oncology, radiation oncology, surgery, pathology, etc.). The example interface 300 also includes a selected date range 330 for playback and review. Once the pathology report state 310 has been selected for playback from the list, the user is brought into the application in the pathology report state and can manipulate, modify, and/or execute functionality in the pathology report state starting from the saved state information, for example. For example, the saved pathology state can include an opened pop-up window 340 including text related to the pathology report.

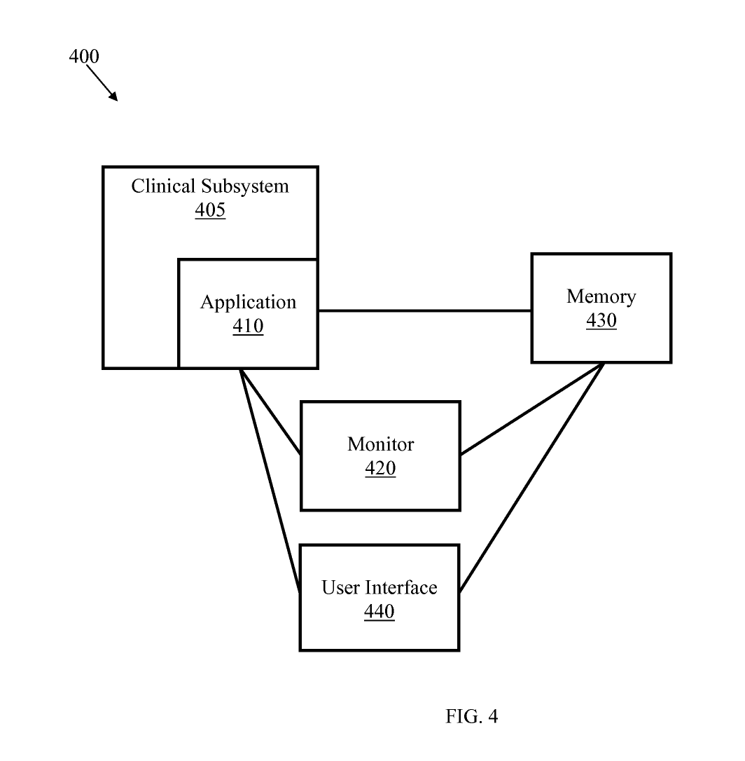

FIG. 4 illustrates an example software application state capture and playback system 400. The system 400 includes a monitor 420 monitoring execution of an application 410 on a clinical subsystem 405. The application 410 is displayed via a user interface 440. The monitor 420 can save state and/or other application information in a memory 430.

In the example system 400, the monitor 420 monitors the state of the application 410 being executed. The monitor 420 can be a passive background monitor and/or an active monitor visible to and manipulatable by a user. The monitor 420 can, automatically (e.g., according to a predefined and/or other system setting, preference, criterion etc.) and/or based on user input record and save one or more application 410 states for later playback and review. A saved review can include a plurality of states tracking execution of the application 410 with respect to certain data and/or other input, for example.

Using the monitor 420, a user can select a review saved in memory 430 for playback via the user interface 440, for example. For a selected review, a playback interface associated with the monitor 420 and displayed via the user interface 440 can include a list of saved software state(s) and/or review(s). One or more user interface controls allow a user to playback, manipulate, reorder, remove, etc., one or more reviews and/or states with in a review, for example.

For a selected state to be reviewed, one or more controls facilitate playback of the selected software state. As shown in the examples of FIGS. 1-3, a user can move back and forth between saved states using one or more user interface 440 controls. The user can start playback of one or more states in the sequence based on a certain (e.g., user and/or system/application defined) interval between each state, for example. Playback can be stopped, a saved state can be modified, and a current state can be recorded and added to the selected review sequence, for example.

Upon playing back a saved state for the application 410, for example, a user can continue execution of the application 410 and deviate from the saved state and/or subsequent saved state(s) in a saved application 410 review. The user can save new state information in memory 430 via the monitor 420 in conjunction with the selected review and/or a new saved application 410 review, for example.

In certain examples, the clinical subsystem 405 can include one or more of a radiology information system (RIS), a picture archiving and communication system (PACS), Computer Physician Order Entry (CPOE), an electronic medical record (EMR), Clinical Information System (CIS), Cardiovascular Information System (CVIS), Library Information System (LIS), and/or other healthcare information system (HIS), etc. An integrated user interface 440 facilitating access to the application 410 and/or associated patient record can include a context manager, such as a clinical context object workgroup (CCOW) context manager and/or other rules-based context manager. Components can communicate via wired and/or wireless connections on one or more processing units, such as computers, medical systems, storage devices, custom processors, and/or other processing units. Components can be implemented separately and/or integrated in various forms in hardware, software and/or firmware, for example.

In certain examples, the user interface 440 can be provided using a handheld or mobile device, for example.

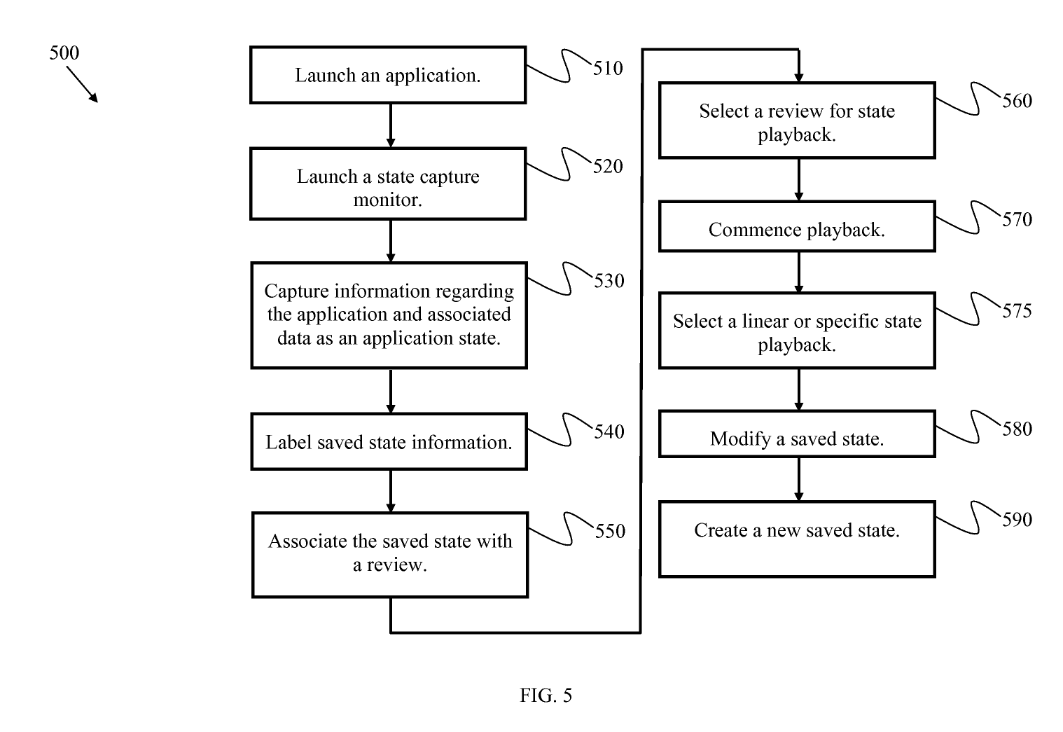

FIG. 5 is a flow diagram representative of example machine readable instructions that can be executed to implement the example systems shown in FIGS. 1-4 and/or portions of one or more of those systems. The example process(es) of FIG. 5 can be performed using a processor, a controller and/or any other suitable processing device. For example, the example process(es) of FIG. 5 can be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example process(es) of FIG. 5 can be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example process(es) of FIG. 5 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example process(es) of FIG. 5 can be implemented manually or as any combination(s) of any of the foregoing techniques, for example, any combination of firmware, software, discrete logic and/or hardware. Further, although the example process(es) of FIG. 5 is described with reference to the flow diagram of FIG. 5, other methods of implementing the process(es) of FIG. 5 can be employed. For example, the order of execution of the blocks can be changed, and/or some of the blocks described can be changed, eliminated, sub-divided, or combined. Additionally, any or all of the example process(es) of FIG. 5 can be performed sequentially and/or in parallel by, for example, separate processing threads, processors, devices, discrete logic, circuits, etc.

FIG. 5 depicts a flow diagram for an example method 500 for software application state capture and playback. At block 510, an application is launched. For example, a patient record viewing and collaboration application is launch. At block 520, a state capture monitor is launched. For example, a user and/or automated system function/preference executes the state capture monitor to track and capture the application and associated data.

At block 530, information regarding application execution and associated data is captured. For example, a physician wishes to track his or her information viewer application workflow and to save that workflow for later reuse and/or for training/assistance of another user. Information regarding the physician user's execution of the application and associated data involved in that execution are tracked and captured for later retrieval. At block 540, captured application state information (e.g., application execution and associated data can be labeled for later retrieval. At block 550, captured state information can be associated with a review. For example, a summary state can be labeled and associated with a patient information review for later retrieval.

At block 560, a second user selects a review for state playback. For example, the user selects the patient information review from a list of available reviews for the second user. At block 570, playback commences. At block 575, the user can select a linear state playback and/or can select a specific captured state for playback. For example, the user can launch the patient information review and progress through the saved states linearly and/or can view a list of saved states for the review and select one to which the user can jump. If the user jumps to a saved state (e.g., a later and/or prior saved state), application settings, data, etc., are updated for the user in conjunction with the saved state playback, for example.

At block 580, a user can modify a saved state. For example, after saved state playback, a user can modify the application state and/or associated data and save the updated state information. At block 590, a user can create a new saved state. For example, the user can deviate from the saved state path in the selected review and create a new state capture for saving and later retrieval.

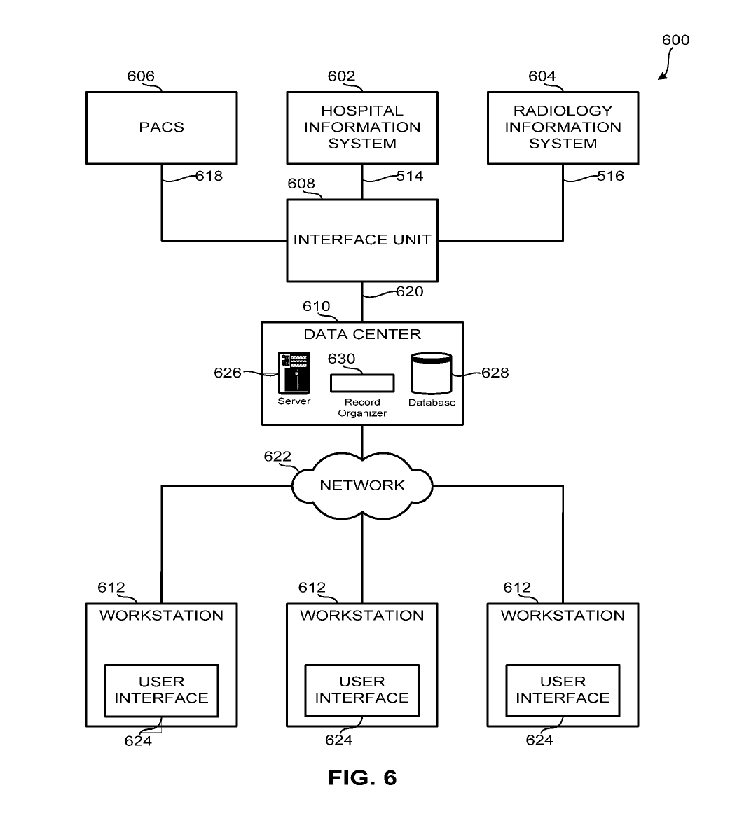

FIG. 6 shows a block diagram of an example clinical information system 600 capable of implementing the example methods and systems described herein. The example clinical information system 600 includes a hospital information system (HIS) 602, a radiology information system (RIS) 604, a picture archiving and communication system (PACS) 606, an interface unit 608, a data center 610, and a plurality of workstations 612. In the illustrated example, the HIS 602, the RIS 604, and the PACS 606 are housed in a healthcare facility and locally archived. However, in other implementations, the HIS 602, the RIS 604, and/or the PACS 606 can be housed one or more other suitable locations. In certain implementations, one or more of the PACS 606, RIS 604, HIS 602, etc., can be implemented remotely via a thin client and/or downloadable software solution. Furthermore, one or more components of the clinical information system 600 can be combined and/or implemented together. For example, the RIS 604 and/or the PACS 606 can be integrated with the HIS 602; the PACS 606 can be integrated with the RIS 604; and/or the three example information systems 602, 604, and/or 606 can be integrated together. In other example implementations, the clinical information system 600 includes a subset of the illustrated information systems 602, 604, and/or 606. For example, the clinical information system 600 can include only one or two of the HIS 602, the RIS 604, and/or the PACS 606. Information (e.g., scheduling, test results, observations, diagnosis, etc.) can be entered into the HIS 602, the RIS 604, and/or the PACS 606 by healthcare practitioners (e.g., radiologists, physicians, and/or technicians) before and/or after patient examination.

The HIS 602 stores medical information such as clinical reports, patient information, and/or administrative information received from, for example, personnel at a hospital, clinic, and/or a physician's office. The RIS 604 stores information such as, for example, radiology reports, messages, warnings, alerts, patient scheduling information, patient demographic data, patient tracking information, and/or physician and patient status monitors. Additionally, the RIS 604 enables exam order entry (e.g., ordering an x-ray of a patient) and image and film tracking (e.g., tracking identities of one or more people that have checked out a film). In some examples, information in the RIS 604 is formatted according to the HL-7 (Health Level Seven) clinical communication protocol.

The PACS 606 stores medical images (e.g., x-rays, scans, three-dimensional renderings, etc.) as, for example, digital images in a database or registry. In some examples, the medical images are stored in the PACS 606 using the Digital Imaging and Communications in Medicine (“DICOM”) format. Images are stored in the PACS 306 by healthcare practitioners (e.g., imaging technicians, physicians, radiologists) after a medical imaging of a patient and/or are automatically transmitted from medical imaging devices to the PACS 606 for storage. In some examples, the PACS 606 can also include a display device and/or viewing workstation to enable a healthcare practitioner to communicate with the PACS 606.

The interface unit 608 includes a hospital information system interface connection 614, a radiology information system interface connection 616, a PACS interface connection 618, and a data center interface connection 620. The interface unit 608 facilities communication among the HIS 602, the RIS 604, the PACS 606, and/or the data center 610. The interface connections 614, 616, 618, and 620 can be implemented by, for example, a Wide Area Network (“WAN”) such as a private network or the Internet. Accordingly, the interface unit 608 includes one or more communication components such as, for example, an Ethernet device, an asynchronous transfer mode (“ATM”) device, an 802.11 device, a DSL modem, a cable modem, a cellular modem, etc. In turn, the data center 610 communicates with the plurality of workstations 612, via a network 622, implemented at a plurality of locations (e.g., a hospital, clinic, doctor's office, other medical office, or terminal, etc.). The network 622 is implemented by, for example, the Internet, an intranet, a private network, a wired or wireless Local Area Network, and/or a wired or wireless Wide Area Network. In some examples, the interface unit 608 also includes a broker (e.g., a Mitra Imaging's PACS Broker) to allow medical information and medical images to be transmitted together and stored together.

In operation, the interface unit 608 receives images, medical reports, administrative information, and/or other clinical information from the information systems 602, 604, 606 via the interface connections 614, 616, 618. If necessary (e.g., when different formats of the received information are incompatible), the interface unit 608 translates or reformats (e.g., into Structured Query Language (“SQL”) or standard text) the medical information, such as medical reports, to be properly stored at the data center 610. The reformatted medical information can be transmitted using a transmission protocol to enable different medical information to share common identification elements, such as a patient name or social security number. Next, the interface unit 608 transmits the medical information to the data center 610 via the data center interface connection 620. Finally, medical information is stored in the data center 610 in, for example, the DICOM format, which enables medical images and corresponding medical information to be transmitted and stored together.

The medical information is later viewable and easily retrievable at one or more of the workstations 612 (e.g., by their common identification element, such as a patient name or record number). The workstations 612 can be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. The workstations 612 receive commands and/or other input from a user via, for example, a keyboard, mouse, track ball, microphone, etc. As shown in FIG. 6, the workstations 612 are connected to the network 622 and, thus, can communicate with each other, the data center 610, and/or any other device coupled to the network 622. The workstations 612 are capable of implementing a user interface 624 to enable a healthcare practitioner to interact with the clinical information system 600. For example, in response to a request from a physician, the user interface 624 presents a patient medical history. Additionally, the user interface 624 includes one or more options related to the example methods and apparatus described herein to organize such a medical history using classification and severity parameters.

The example data center 610 of FIG. 6 is an archive to store information such as, for example, images, data, medical reports, and/or, more generally, patient medical records. In addition, the data center 610 can also serve as a central conduit to information located at other sources such as, for example, local archives, hospital information systems/radiology information systems (e.g., the HIS 602 and/or the RIS 604), or medical imaging/storage systems (e.g., the PACS 606 and/or connected imaging modalities). That is, the data center 610 can store links or indicators (e.g., identification numbers, patient names, or record numbers) to information. In the illustrated example, the data center 610 is managed by an application server provider (“ASP”) and is located in a centralized location that can be accessed by a plurality of systems and facilities (e.g., hospitals, clinics, doctor's offices, other medical offices, and/or terminals). In some examples, the data center 610 can be spatially distant from the HIS 602, the RIS 604, and/or the PACS 606 (e.g., at General Electric® headquarters).

The example data center 610 of FIG. 6 includes a server 626, a database 628, and a record organizer 630. The server 626 receives, processes, and conveys information to and from the components of the clinical information system 600. The database 628 stores the medical information described herein and provides access thereto. The example record organizer 630 of FIG. 6 manages patient medical histories, for example. The record organizer 630 can also assist in procedure scheduling, for example.

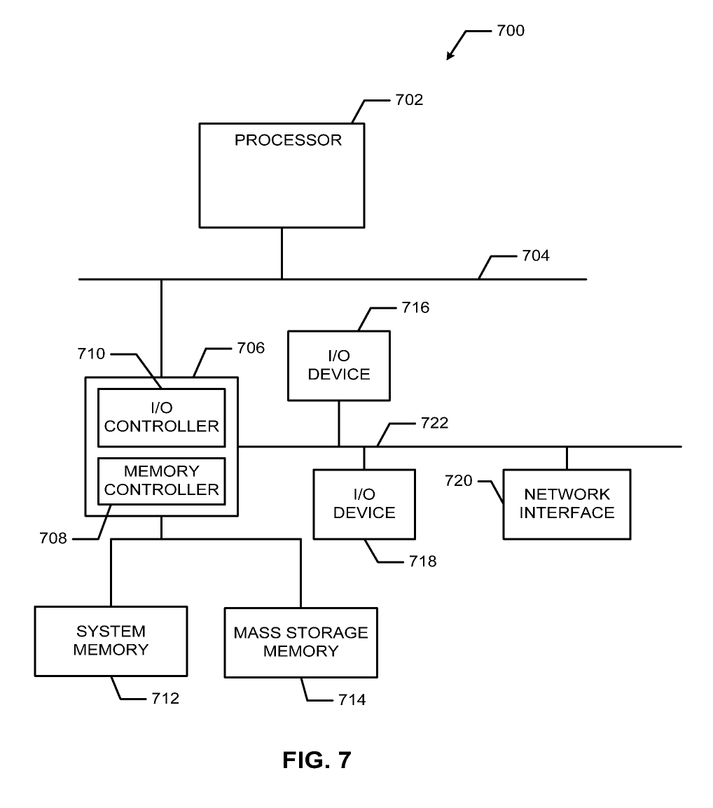

FIG. 7 is a block diagram of an example processor system 710 that can be used to implement systems, apparatus, and methods described herein. As shown in FIG. 7, the processor system 710 includes a processor 712 that is coupled to an interconnection bus 714. The processor 712 can be any suitable processor, processing unit, or microprocessor, for example. Although not shown in FIG. 7, the system 710 can be a multi-processor system and, thus, can include one or more additional processors that are identical or similar to the processor 712 and that are communicatively coupled to the interconnection bus 714. For example, “cloud” and/or “grid” based computing can be employed for three dimensional processing using Euclidian vectors and linear algebra, as described above. In certain examples, a Bayesian algorithm can be used in an evolving model combining multiple executions of multiple algorithms. As certain mappings are resolved, a probability associated with other remaining mappings changes.

The processor 712 of FIG. 7 is coupled to a chipset 718, which includes a memory controller 720 and an input/output (“I/O”) controller 722. As is well known, a chipset typically provides I/O and memory management functions as well as a plurality of general purpose and/or special purpose registers, timers, etc. that are accessible or used by one or more processors coupled to the chipset 718. The memory controller 720 performs functions that enable the processor 712 (or processors if there are multiple processors) to access a system memory 724 and a mass storage memory 725.

The system memory 724 can include any desired type of volatile and/or non-volatile memory such as, for example, static random access memory (SRAM), dynamic random access memory (DRAM), flash memory, read-only memory (ROM), etc. The mass storage memory 725 can include any desired type of mass storage device including hard disk drives, optical drives, tape storage devices, etc.

The I/O controller 722 performs functions that enable the processor 712 to communicate with peripheral input/output (“I/O”) devices 726 and 728 and a network interface 730 via an I/O bus 732. The I/O devices 726 and 728 can be any desired type of I/O device such as, for example, a keyboard, a video display or monitor, a mouse, etc. The network interface 730 can be, for example, an Ethernet device, an asynchronous transfer mode (“ATM”) device, an 802.11 device, a DSL modem, a cable modem, a cellular modem, etc., that enables the processor system 710 to communicate with another processor system.

While the memory controller 720 and the I/O controller 722 are depicted in FIG. 7 as separate blocks within the chipset 718, the functions performed by these blocks can be integrated within a single semiconductor circuit or can be implemented using two or more separate integrated circuits.

Certain embodiments contemplate methods, systems and computer program products on any machine-readable media to implement functionality described above. Certain embodiments can be implemented using an existing computer processor, or by a special purpose computer processor incorporated for this or another purpose or by a hardwired and/or firmware system, for example.

Some or all of the system, apparatus, and/or article of manufacture components described above, or parts thereof, can be implemented using instructions, code, and/or other software and/or firmware, etc. stored on a machine accessible or readable medium and executable by, for example, a processor system (e.g., the example processor system 710 of FIG. 7). When any of the appended claims are read to cover a purely software and/or firmware implementation, at least one of the components is hereby expressly defined to include a tangible medium such as a memory, DVD, CD, Blu-ray disc, etc. storing the software and/or firmware.

Certain embodiments contemplate methods, systems and computer program products on any machine-readable media to implement functionality described above. Certain embodiments can be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media can be any available media that can be accessed by a general purpose or special purpose computer or other machine with a processor. By way of example, such computer-readable media can include RAM, ROM, PROM, EPROM, EEPROM, Flash, CD-ROM, DVD, Blu-ray or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions include, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention can be practiced in a networked environment using logical connections to one or more remote computers having processors. Logical connections can include a local area network (LAN) and a wide area network (WAN) that are presented here by way of example and not limitation. Such networking environments are commonplace in office-wide or enterprise-wide computer networks, intranets and the Internet and can use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention can also be practiced in distributed computing environments where tasks are performed by local and remote processing devices that are linked (either by hardwired links, wireless links, or by a combination of hardwired or wireless links) through a communications network. In a distributed computing environment, program modules can be located in both local and remote memory storage devices.

While the invention has been described with reference to certain embodiments, it will be understood by those skilled in the art that various changes can be made and equivalents can be substituted without departing from the scope of the invention. In addition, many modifications can be made to adapt a particular situation or material to the teachings of the invention without departing from its scope. Therefore, it is intended that the invention not be limited to the particular embodiment disclosed, but that the invention will include all embodiments falling within the scope of the appended claims.

1. An application state capture and playback system comprising:
a user interface to display an application and associated data to a user for interaction by the user, the user interface comprising:
a player to facilitate playback of one or more saved states from the application, each of the one or more saved states including an application setting and associated data, the player including a plurality of controls to facilitate selection, playback, and modification of each of the one or more saved states, the player to provide a list of one or more saved states for selection and playback by the user, the playback of a selected state to automatically take the user to a point in execution of the application associated with the application setting and associate data and to allow the user to dynamically execute the application from the point.

2. The system of claim 1, wherein the player is to provide a list of one or more reviews, each review including a list of one or more states for selection and playback within the review.

3. The system of claim 1, wherein the plurality of controls includes a control to allow the user to save and add a new state to the list of one or more states for selection and playback

4. The system of claim 1, wherein the plurality of controls includes a control to allow the user to delete a saved state.

5. The system of claim 1, wherein the plurality of controls includes a control to allow the user to reorder one or more of the saved states.

6. The system of claim 1, wherein each of the one or more states is associated with a label.

7. The system of claim 1, further comprising a monitor to capture execution of the application to create a saved state.

8. The system of claim 7, wherein the monitor and the player are to allow a user to manually initiate capture of an application state.

9. A tangible computer readable storage medium including executable program instructions which, when executed by a computer processor, cause the computer to implement an application state capture and playback system, the system comprising:
a user interface to display an application and associated data to a user for interaction by the user, the user interface comprising:
a player to facilitate playback of one or more saved states from the application, each of the one or more saved states including an application setting and associated data, the player including a plurality of controls to facilitate selection, playback, and modification of each of the one or more saved states, the player to provide a list of one or more saved states for selection and playback by the user, the playback of a selected state to automatically take the user to a point in execution of the application associated with the application setting and associate data and to allow the user to dynamically execute the application from the point.

10. The computer readable storage medium of claim 9, wherein the player is to provide a list of one or more reviews, each review including a list of one or more states for selection and playback within the review.

11. The computer readable storage medium of claim 9, wherein the plurality of controls includes a control to allow the user to save and add a new state to the list of one or more states for selection and playback

12. The computer readable storage medium of claim 9, wherein the plurality of controls includes a control to allow the user to delete a saved state.

13. The computer readable storage medium of claim 9, wherein the plurality of controls includes a control to allow the user to reorder one or more of the saved states.

14. The computer readable storage medium of claim 9, wherein each of the one or more states is associated with a label.

15. The computer readable storage medium of claim 9, further comprising a monitor to capture execution of the application to create a saved state.

16. The computer readable storage medium of claim 15, wherein the monitor and the player are to allow a user to manually initiate capture of an application state.

17. A computer-implemented method comprising:
displaying an application and associated data to a user for interaction by the user via a user interface;
providing, via the user interface, a player to facilitate playback of one or more saved states from the application, each of the one or more saved states including an application setting and associated data, the player including a plurality of controls to facilitate selection, playback, and modification of each of the one or more saved states, the player to provide a list of one or more saved states for selection and playback by the user, the playback of a selected state to automatically take the user to a point in execution of the application associated with the application setting and associate data and to allow the user to dynamically execute the application from the point;
accepting selection by the user of a saved state, via the player, for playback; and
initiating playback of the selected state to bring the user to the point in the execution of the application associated with the saved state.

18. The method of claim 17, further comprising providing, via the player, one or more reviews for selection by the user, each review including a list of one or more states for selection and playback within the review.

19. The method of claim 18, further comprising facilitating playback of a selected review according to a preset interval between saved states in the review.

20. The method of claim 17, further comprising facilitating user capture of a saved state for later playback.

21. The method of claim 17, further comprising accepting user modification of a saved state.
